(19) United States
(12) Patent Application Publication
(10) Pub. No.: US 2013/0134209 A1
(43) Pub. Date: May 30, 2013

(54) CARRIER FOR CIRCUIT BOARD

(71) Applicant: LI-HSUAN LU, New Taipei (TW)

(72) Inventor: LI-HSUAN LU, New Taipei (TW)

(73) Assignee: Cheng Uei Precision Industry Co., LTD., New Taipei City (TW)

(21) Appl. No.: 13/306,974

(22) Filed: Nov. 29, 2011

(51) Int. Cl. B23K 3/08

(52) U.S. Cl. 228/49.5

(57) ABSTRACT

A circuit board carrier comprises an upper and a lower covers that construct a space for accommodating a circuit board. The upper cover has a recess, and an inner portion of the recess has two positioning elements symmetrically arranged. The positioning elements are movable in a push-and-pull motion. An inner wall of the recess has position limiting elements arranged at four corners thereof. The limiting elements are located between the inner wall of the recess and the positioning elements for confining the motion of the limiting elements and eliminating an effect of product tolerance on manufacturing the board. The carrier implements Y-axis and Z-axis confinement, avoids vibration occurred when the board passes an oven, and avoids a sliding error occurred due to human operations, by springs and pressing bulks fastened to bottom surfaces of the positioning elements and down pressing spring structure disposed below the upper cover.

### TECHNICAL FIELD OF THE INVENTION

The present invention relates to a circuit board carrier, and more particularly, to a circuit board carrier comprising an upper cover and a lower cover.

### BACKGROUND OF THE INVENTION

As the performance of integrated circuits is improved, the circuit boards tend to be made as small, light, and thin ones. Related designs of the circuit boards become more refined and complicated, and thereby making soldering precision of the circuit boards increased. In producing the circuit boards today, a wave soldering method is mainly applied to solder pin elements. A small circuit board is fastened to a carrier and then put into an oven for being soldered. Since the circuit board is apt to be curved and deformed by heat in the soldering procedure, and weld positions are required to be precise, the requirement for the circuit board carrier is higher in a soldering craft.

In conventional skills, a circuit board carrier used in the oven generally comprises a bottom plate and a frame fastened to and surrounded around the bottom plate. An occupant space is also formed on the bottom plate for accommodating the circuit board. In addition, the bottom plate is perforated to form hollowed-out holes that match corresponding soldering pins of electronic elements of the circuit board. In the conventional circuit board carrier, the circuit board is well fixed in the soldering procedure. However, it usually adopts a rigid fastening approach to fix the circuit board. This restricts the size of products. The conventional circuit board carrier can not confine the motion of the circuit board according to product tolerance and is easily to be vibrated. A sliding error may also occur due to human operations.

### SUMMARY OF THE INVENTION

Accordingly, the objective of the present invention is to provide a circuit board carrier for overcoming an effect of product tolerance of a circuit board.

To achieve the above objective, adopted technical schemes are described as below:

A circuit board carrier is disclosed. The circuit board is utilized for carrying a circuit board and disposing a connecter that is to be soldered on the circuit board. The connector and the circuit board are put into an oven for soldering together. Said circuit board carrier comprises an upper cover and a lower cover. The upper cover and the lower cover construct an accommodating space for accommodating the circuit board. The upper cover has a recess, and an inner portion of the recess has a positioning element and a plurality of position limiting elements disposed therein. The positioning element is movable in a push-and-pull motion. The position limiting elements are respectively located between an inner wall of the recess and the positioning element.

Preferably, the positioning element can be a C-shaped structural element. The ends of the positioning element are protruded to form two push-and-pull protrusions that are exposed with respective to the upper cover of the circuit board carrier. The push-and-pull protrusions are utilized for adjusting the positions of inner structures of the carrier.

Preferably, the number of the position limiting elements is four. The four position limiting elements are symmetrically distributed at four corners of the recess. Any one of the position limiting elements can be a V-shaped spring.

A plurality of elastic structures arranged on a horizontal surface and pressing bulks connecting to the elastic structures are fastened onto a bottom of the positioning element. A mechanical interference is occurred between the pressing bulks and the connector.

Preferably, the spring structures and the pressing bulks are located in trenches that is prearranged in the lower cover.

Further, the upper cover has a plurality of down pressing spring structures.

Each down pressing spring structure has a down pressing column disposed at an end thereof.

By a simple and artful structural design, the circuit board carrier of the present invention implements Y-axis confinement and Z-axis confinement of the circuit board, and by using the elastic elements, the circuit board carrier of the present invention eliminates an adverse effect, caused by product tolerance of the circuit board, on a soldering craft.

### BRIEF DESCRIPTION OF THE DRAWINGS

FIG. 1 is a perspective view of a circuit board carrier in accordance with an embodiment of the present invention.

FIG. 2 is a schematic view of an inner structure of the circuit board carrier in accordance with the embodiment of the present invention.

FIG. 3 is another schematic view of the inner structure of the circuit board carrier in accordance with the embodiment of the present invention.

FIG. 4 is a partial enlarged view A as shown in FIG. 3.

FIG. 5 is still another schematic view of the inner structure of the circuit board carrier in accordance with the embodiment of the present invention.

FIG. 6 is a partial enlarged view B as shown in FIG. 5.

### DETAILED DESCRIPTION OF THE INVENTION

In order to illustrate the techniques, structural features, achieved objectives and effects of the present invention in details, embodiments are provided in conjunction with drawings and are described as follows.

In the embodiments of the present invention, a direction along a long edge of the circuit board carrier is defined as a X-axis direction, a direction along a short edge thereof is defined as a Y-axis direction, and an upward direction of the circuit board carrier is defined as a Z-axis direction. The circuit board carrier is utilized for carrying a circuit board and disposing a connecter that is to be soldered on the circuit board. The connector and the circuit board are put into an oven for soldering together.

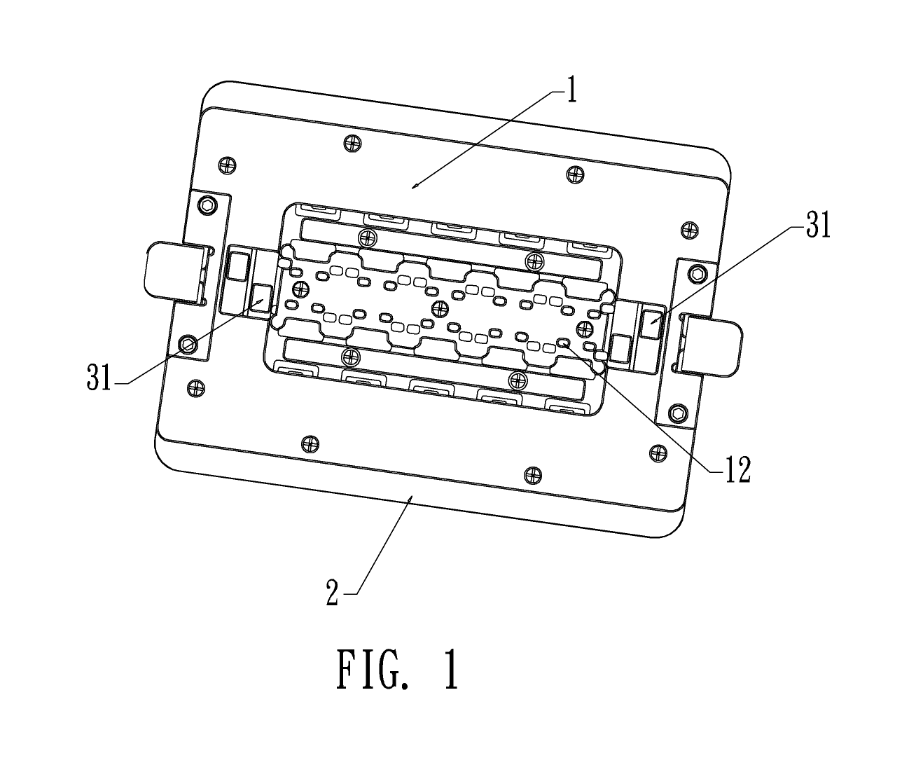

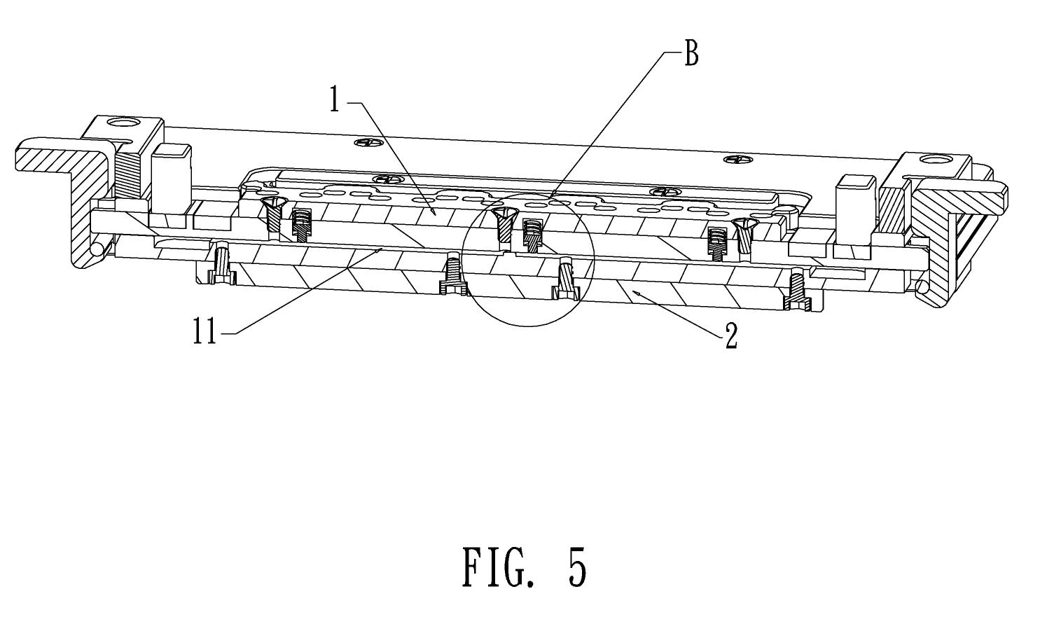

As shown in FIG. 1, the circuit board carrier comprises an upper cover 1 and a lower cover 2. A part enclosed by inner portions of the upper cover 1 and the lower cover 2 constructs an accommodating space 11 for accommodating the circuit board. The inner structure of the circuit board carrier is illustrated in FIG. 5. In addition, the upper cover 1 and the lower cover 2 have a plurality of hollowed-out holes 12 disposed at middle portions thereof for exposing soldering pins of the circuit board.

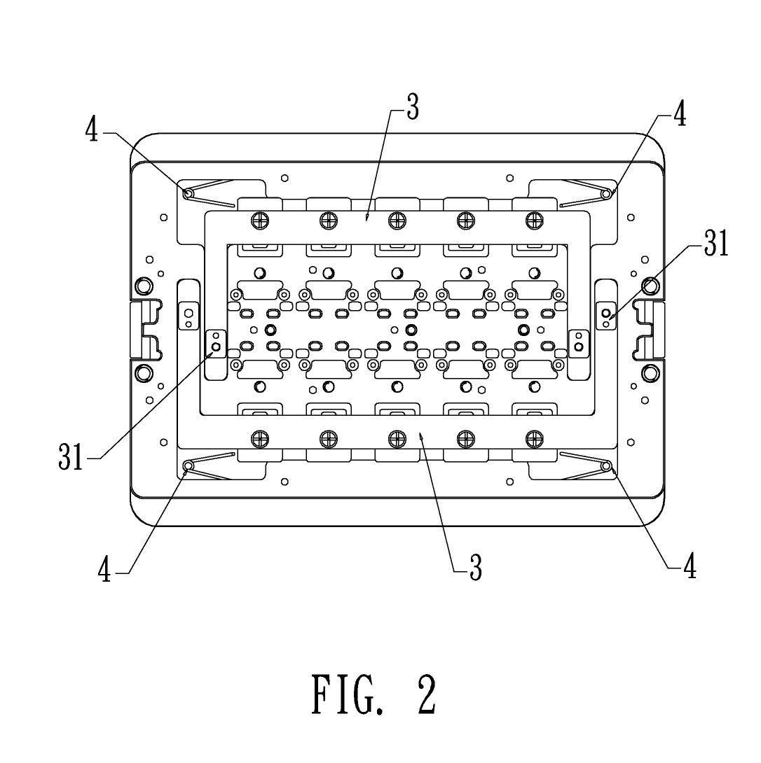

The inner portion of the upper cover 1 is excavated to form a recess, and two movable positioning elements 3 are disposed in the recess. In the present embodiment, each positioning element 3 is a C-shaped structural element. The two positioning elements 3 can be arranged respectively in an outer layer and an inner layer as shown in FIG. 2, and also can be arranged in the recess in an interlaced form. The ends of each positioning element 3 are protruded to form two push-and-pull protrusions 31 that are exposed with respective to the upper cover 1 of the circuit board carrier. The push-and-pull protrusions 31 are utilized for adjusting the positions of the positioning elements 3 of the carrier. Preferably, as shown in FIG. 2, the inner portion of the upper cover 1 has four position limiting elements 4 fastened to four corners of the recess. In the present embodiment, the position limiting elements 4 can be V-shaped springs. The position limiting element 4 is fixed between an inner wall of the recess of the upper cover 1 and an outer wall of the positioning element 3. Under the action of the position limiting elements 4 and the recess of the upper cover 1, the positioning element 3 is retained on the inner wall of the recess, and thereby the positioning element 3 is confined to move along the Y-axis direction.

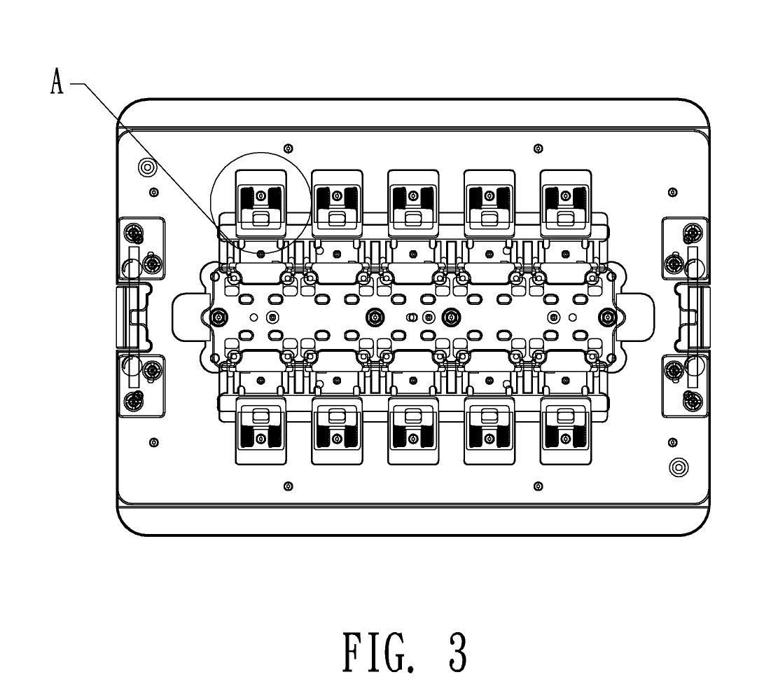

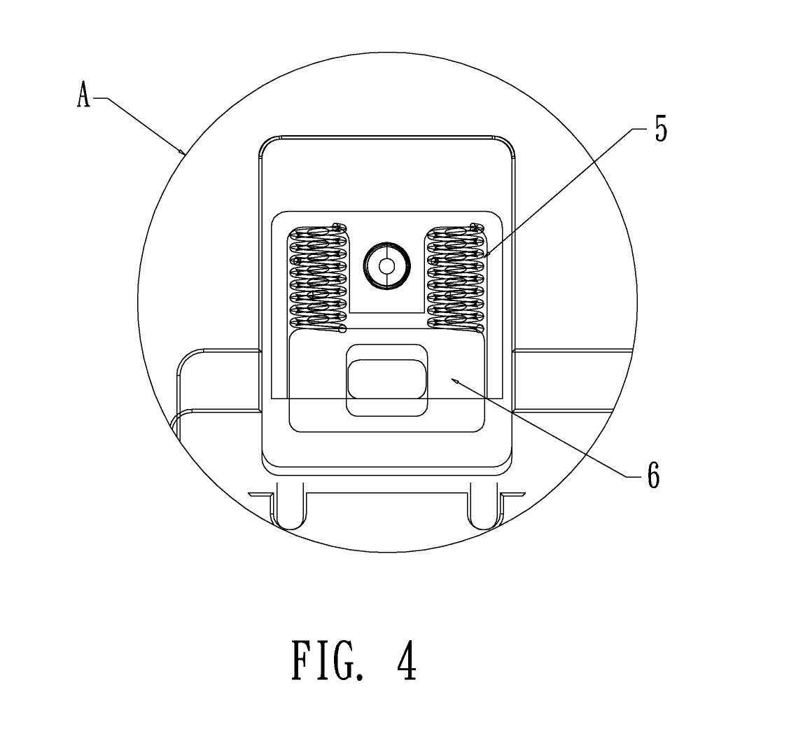

In addition, the circuit board carrier of the present invention has a plurality of elastic structures fastened onto bottom surfaces of the two positioning elements 3. The elastic structures are capable of stretching out and drawing back along the Y-axis direction. In the present embodiment, each elastic structure is consisted of at least one spring 5 and a pressing bulk 6. Preferably, two springs 5 and one pressing bulk 6 connected thereto form a stable elastic structure. The elastic structures are respectively located in a plurality of trenches that are prearranged in the inner portion of the lower cover 2. The elastic structures are specifically illustrated in FIG. 3 and a partial enlarged view A of FIG. 4. After the upper cover 1 is set up, the pressing bulk 6 is pushed to the connector of the circuit board under the force applied by the spring 5. The pressing bulk 6 and the connector to be soldered have a mechanical interference occurred therebetween, and thereby pressing the circuit board tightly. The circuit board carrier implements Y-axis confinement of the circuit board by the actions of the positioning elements 3, the position limiting element 4, the springs 5, and the pressing bulks 6.

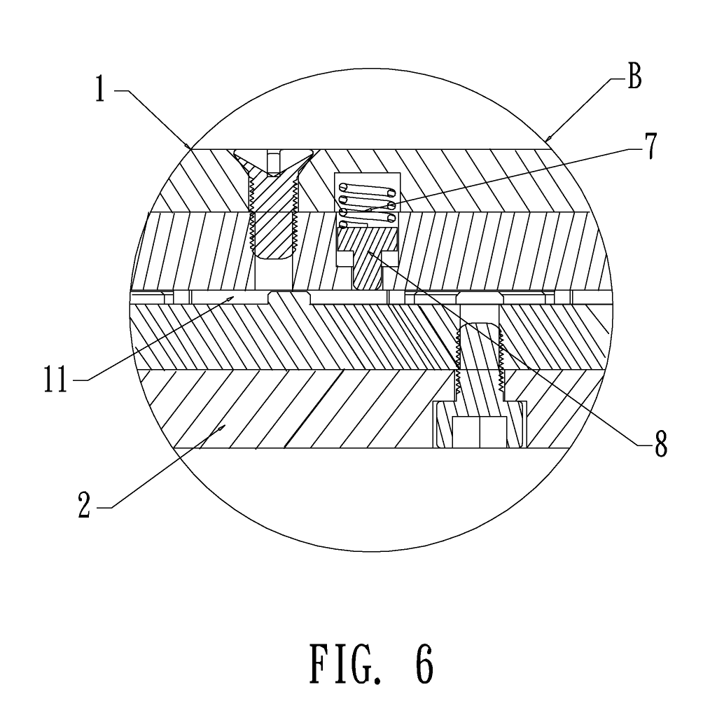

Furthermore, the upper cover 1 of the circuit board carrier has a plurality of down pressing spring structures 7, and each down pressing spring structure 7 has a down pressing column 8 disposed at an end thereof. The down pressing spring structures 7 are specifically illustrated in FIG. 5 and a partial enlarged view B of FIG. 6. The plural down pressing spring structures 7 are uniformly distributed in the inner portion of the upper cover 1. After the upper cover 1 is set up, the action of the down pressing columns 8 is applied on the circuit board that is inserted into the circuit board carrier horizontally, and also applied on the connector that is to be soldered, and thereby pressing the circuit board tightly and restricting the Z-axis directional motion of the circuit board.

After the upper cover 1 is set up, the circuit board carrier completely confines the connector to be located in a restricting surface by the actions of the positioning elements 3, the position limiting element 4, the springs 5, and the pressing bulks 6 of the Y-axis direction, and the down pressing spring structures 7 of the Z-axis direction. Therefore, the Y-axis confinement and the Z-axis confinement of the circuit board are achieved.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A circuit board carrier, utilized for carrying a circuit board and disposing a connecter that is to be soldered on the circuit board, the connector and the circuit board being put into an oven for soldering together, said circuit board carrier comprising:
an upper cover and a lower cover, the upper cover and the lower cover constructing an accommodating space for accommodating the circuit board;
wherein the upper cover has a recess, an inner portion of the recess has a positioning element and a plurality of position limiting elements disposed therein, the positioning element is movable in a push-and-pull motion, the position limiting elements are respectively located between an inner wall of the recess and the positioning element.

2. The circuit board carrier according to claim 1, wherein the position limiting elements are V-shaped springs symmetrically distributed at four corners of the recess.

3. The circuit board carrier according to claim 1, wherein the positioning element is a C-shaped structural element, a plurality of elastic structures capable of stretching out and drawing back along a Y-axis direction are fastened onto a bottom of the positioning element, each of the elastic structures has a spring arranged on a horizontal surface and a pressing bulk connecting to the spring, a mechanical interference is occurred between the pressing bulk and the connector.

4. The circuit board carrier according to claim 3, wherein the lower cover has trenches prearranged thereon, the spring and the pressing bulk of each of the elastic structures are located in the prearranged trenches of the lower cover.

5. The circuit board carrier according to claim 1, wherein the upper cover has a plurality of down pressing spring structures.

6. The circuit board carrier according to claim 5, wherein each down pressing spring structure has a down pressing column disposed at an end thereof.
